(19) United States
(12) Patent Application Publication
(10) Pub. No.: US 2016/0316973 A1
(43) Pub. Date: Nov. 3, 2016

(54) Free standing egg cracking receptacle

(71) Applicant: Lyle James Christiansen, Morris, MN (US)

(72) Inventor: Lyle James Christiansen, Morris, MN (US)

(21) Appl. No.: 14/545,404

(22) Filed: May 1, 2015

(51) Int. Cl. A47J 43/14

(52) U.S. Cl. CPC A47J 43/14

(57) ABSTRACT

A free standing egg cracking receptacle comprising two body segments (10) which are attached by a hinge (14), the lower segment of the receptacle comprises a concavity (18) located on the lower segments' surface which has the shape of a lower part of an egg. The upper segment of the receptacle comprises a concavity (18) located on the upper segments' lower surface which comprises the shape of the upper part of an egg and the concavity comprises a projection (22) located on the central part of the concavity.

### CROSS-REFERENCE TO RELATED APPLICATIONS

Not applicable.

### BACKGROUND

1. Field of Invention

This invention relates to an egg cracking receptacle, specifically to an egg cracking receptacle which is free standing.

2. Description of Prior Arty

The task of cracking an egg is a frustrating task because one normally cracks an egg by striking it against the rim of a frying pan or bowl. Sometimes the egg is crushed too far and the yolk of the egg is broken. Inventors have attempted for centuries to develop an egg cracker which would solve these problems, such as:

N. T. Sparks's eggshell cracker, U.S. Pat. No. 3,494,397 which shows an eggshell cracker with a flat type body which probably would be difficult to use in order to not crush the egg as it comprises no stoppers to restrict the downward movement of the eggshell cracker.

Current inventors free standing egg cracking receptacle comprises a body construction which allows a projection located on the receptacle to pierce the egg only so deep and so prevents the egg from being crushed.

James Constantine Gevas's egg shell breaker, U.S. Pat. No. 4,106,402A shows an egg shell breaker which comprises an upright shaped body which would have a tendency to tip over in use and comprises many parts in its construction.

Current inventor's free standing egg cracking receptacle comprises a body which is not tall and which would not tip over easily.

### Objects and Advantages

Accordingly, besides the objects and advantages of a body construction for a free standing egg cracking receptacle above, several objects and advantages of the present invention are:

a. to provide a body construction for a free standing egg cracking receptacle which comprises only two segments and also comprises no moving parts.

b. to provide a free standing egg cracking receptacle which comprises a non-slip material attached to said receptacle's bottom which serves to prevent the receptacle from moving while being used and holds it stable while an egg is being cracked.

c. Further objects and advantages are to provide a free standing egg cracking receptacle which, because of its simplicity of construction which comprises only two segments and having no moving parts, would allow it to be easy to manufacture by a plastic molding process.

### DRAWING FIGURES

FIG. 1 shows a front view of a two segment construction of a free standing egg cracking receptacle.

Reference Numeral in Drawings

10 body segments

14 hinge

18 concavities

22 projection

26 non-slip material (not shown)

### SUMMARY

In accordance with the present invention of a free standing egg cracking receptacle, said receptacle is provided with a body which comprises two segments only which are attached to each other by a hinge and the receptacle's two segments comprise no moving parts.

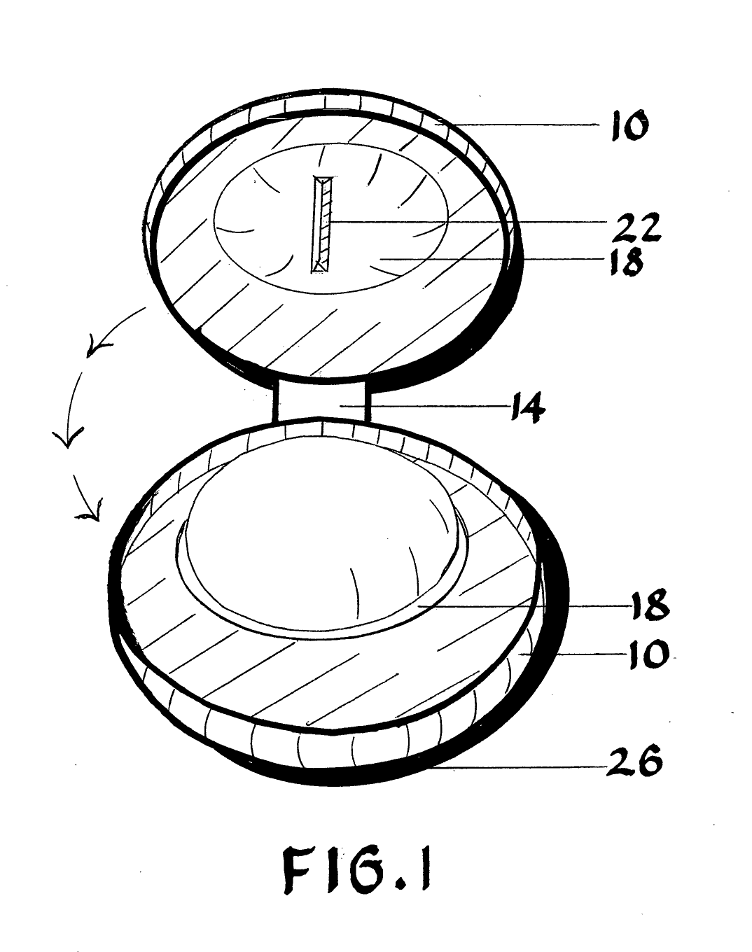

### DESCRIPTION-FIG. 1 Preferred Embodiment

A preferred embodiment of the body construction for a free standing egg cracking receptacle is illustrated in FIG. 1 (front view). The body segments (10) are constructed of a tough plastic which could be any color. A hinge which connects the two segments is also of a tough plastic and heat treated to attach to the top edge and the bottom edge of the two segments, therefore, forming a connecting hinge for the two segments. The concavities (18) are located on the surface of the bottom segment and the surface of the top segment on the receptacle's body. The projection (22) is located in the central part of the concavity on the top segment. A non-slip material (26) is located and attached to the bottom surface of the bottom segment, a rubberized material preferred.

### ALTERNATIVE EMBODIMENTS

The body shape of a free standing egg cracking receptacle could be of many different shapes, such as: round, rectangular, or oval.

### ADVANTAGES

From the description above, a number of advantages of a free standing egg cracking receptacle become evident, such as:

a. a free standing egg cracking receptacle which sets firmly on a kitchen counter and ready for use would be a joy for a user.

b. a free standing egg cracking receptacle which comprises a projection on its top segment which provides the means to crack an egg. And, the two body segments are constructed so that, in use, the hinged segments are only possible to move together until they meet which is a distance slightly more than the diameter of an egg which insures that the egg will not get crushed and the yolk of the egg is left intact.

### OPERATION-FIG. 1

The manner of using a free standing egg cracking receptacle is: a user places an egg onto the concavity 18 located on the surface of the lower segment 10, then lowers the upper-hinged 10 onto the egg, and then presses down on the egg which causes a projection 22 to pierce the egg and crack it. A user then removes the cracked egg from the receptacle and with the thumbs, spreads the shell of the egg further so that the egg's contents are then deposited in a frying pan or bowl.

### CONCLUSION, RAMIFICATIONS, AND SCOPE

Accordingly, a reader will see that the current free standing egg cracking receptacle, when used by a user cracks an egg to a precise depth, so that the egg yolk is not broken and the egg is not crushed.

The body construction of the receptacle comprises two segments connected by a hinge and comprises no moving parts, so because of the receptacles simplicity of its body construction, a manufacturer would be capable of producing the receptacle by a plastic molding process.

The free standing egg cracking receptacle comprises a non-slip material located and attached to the bottom of the receptacle which prevents it from slipping and allows it to be stable while being used.

Thus, the scope of the current invention should be determined by the appended claims and their legal equivalents, rather than by the examples given.

1. A free standing receptacle comprising the means for cracking an egg.

2. The means of claim 1 comprises a projection located on the receptacle which pierces an egg when the receptacle is in use.

3. The body construction of the receptacle of claim 1 comprises only two segments and comprises no moving parts.

4. The two segments of claim 3 comprises an upper and a lower segment which are attached by a hinge.

5. The lower segment of claim 4 comprises a concavity located on its upper surface comprising the shape of the lower part of an egg and the upper segment comprises a concavity located on its under side's surface which comprises the shape of the upper part of an egg.

6. The upper segment's concavity of claim 5 comprises a projection located on its central part which provides the means for cracking an egg.

7. The free standing receptacle of claim 1 comprises a non-slip material attached to its bottom.

8. The body construction of claim 3 with its simplicity of comprising only two segments and comprising no moving parts would allow a manufacturer to produce the receptacle by a plastic molding process.
